(19) United States
(12) Patent Application Publication
(10) Pub. No.: US 2009/0304374 A1
(43) Pub. Date: Dec. 10, 2009

(54) DEVICE FOR TRACKING A MOVING OBJECT

(75) Inventors: Hans Holm FRUEHAUF, Erlangen (DE); Thorsten EDELHAEUSSER, Nuernberg (DE); Dietmar WEISL, Starnberg (DE)

Correspondence Address: SCHOPPE, ZIMMERMANN , STOCKELER & ZINKLER;C/O KEATING & BENNETT, LLP, 1800 Alexander Bell Drive, SUITE 200, Reston, VA, 20191, US

(73) Assignee: Fraunhofer-Gesellschaft Zur Foerderung der angewandten Forschung e.V., Munich (DE)

(21) Appl. No.: 12/388,790

(22) Filed: Feb. 19, 2009

(30) Foreign Application Priority Data
Jun. 5, 2008 (DE) 20 2008 007 520.3

(51) Int. Cl. G03B 17/00

(52) U.S. Cl. 396/153

(57) ABSTRACT

A device for tracking a moving object comprises a receiver, an evaluation unit, a camera and a control unit. The receiver is implemented to receive a signal transmitted by a mobile transmitter which is located at the moving object and follows movements of the object. The evaluation unit determines position data of the moving object from the received signal. The control unit aligns the camera to the moving object based on the determined position data.

### CROSS-REFERENCE TO RELATED APPLICATIONS

This application claims priority from German Utility Model No. 202008007520.3, which was filed on Jun. 5, 2008, and is incorporated herein in its entirety by reference.

### BACKGROUND OF THE INVENTION

Embodiments according to the invention relate to a device for tracking a moving object comprising a receiver, an evaluation unit, a camera and a control unit for aligning the camera to the moving object.

Some embodiments according to the invention relate to an autonomous sensor for the control of a camera head.

Further embodiments according to the invention relate to a wireless sentry tracking camera sensor.

A plurality of systems for tracking moving objects with a camera are currently known. The moving objects may here, for example, be people or animals, but also objects like production goods. Known systems generally try to evaluate the camera image, e.g. by object detection or motion detection by differential images. A big problem here is that the object to be tracked already has to be located in the image field and may not leave the image field of the camera. Additionally, the object to be tracked may not been hidden by other objects. A further disadvantage for some applications is that the above-described systems are no cooperative systems, i.e. that the object to be tracked, in this case a person, cannot influence tracking or monitoring by the camera. This may, for example, lead to difficulties when used with employees. One example of a non-cooperative system would be a radar. The monitored object cannot intentionally elude being controlled. It is a further disadvantage of current systems that the handover of the tracking of moving objects from one camera to another is difficult.

### SUMMARY

According to an embodiment, a device for tracking a moving object may have a receiver which is implemented to receive a signal transmitted by a mobile transmitter which is located at the moving object and follows movements of the object; an evaluation unit for determining position data of the moving object from the received signal; a camera; and a control unit for aligning the camera to the moving object based on the determined position data.

According to a further embodiment, a system for tracking a moving object may have a device for tracking a moving object having a receiver which is implemented to receive a signal transmitted by a mobile transmitter which is located at the moving object and follows movements of the object; an evaluation unit for determining position data of the moving object from the received signal; a camera; and a control unit for aligning the camera to the moving object based on the determined position data, and the mobile transmitter.

Some embodiments according to the invention relate to a method for tracking a moving object according to an embodiment according to the invention. The method comprises receiving a signal, determining position data of the moving object and aligning a camera. The received signal is transmitted by a mobile transmitter which is located at the moving object and follows movements of the object. The position data of the moving object is determined from the received signal. The camera is aligned to the moving object based on the determined position data.

One embodiment according to the invention provides a device for tracking a moving object, comprising a receiver implemented to receive a signal sent from a mobile transmitter located at the moving object and following movements of the object, and an evaluation unit for determining position data of the moving object from the received signal. Further, the device includes a camera and a control unit for directing the camera to the moving object based on the determined position data.

Embodiments according to the invention are based on the central idea that the device aligns the camera to the mobile transmitter. In this way, the tracked object may elude the monitoring by deactivating or putting away the mobile transmitter, which enables providing a cooperative system. As long as the signals of the mobile transmitter can reach the receiver, the tracking of the moving object may also take place if the object to be tracked is hidden by another object.

In some embodiments according to the invention the receiver is implemented to receive radio signals from the mobile transmitter. An optical hiding of the object to be tracked therefore does not impede the alignment of the camera to the object, as the radio signals may reach the receiver anyway.

Some further embodiments according to the invention refer to a system consisting of the device for tracking a moving object and the mobile transmitter.

Further embodiments of the invention relate to systems including more than one transmitter. The different transmitters here comprise different identification features and are implemented to transmit the respective identification feature with a signal. These identification features may then be retrieved from the signals by the evaluation unit, and by a switching means the alignment or direction, respectively, of the camera between the different mobile transmitters may be switched. This switching may also take place automatically, for example every five seconds or via a priority list, wherein the current transmitter having the highest priority is focused by the camera.

Further embodiments according to the invention relate to a device in which more than one camera is used. Tracking the moving object may here handed over from one camera to the next. By this, a complete tracking may be executed across a large range of movement.

### BRIEF DESCRIPTION OF THE DRAWING

In the following, embodiments of the present invention are explained in more detail with reference to the accompanying drawing, in which:

FIG. 1 shows a schematical illustration of a device for tracking a moving object; and

FIG. 2 shows a flow chart of a method for tracking a moving object.

### DETAILED DESCRIPTION OF THE INVENTION

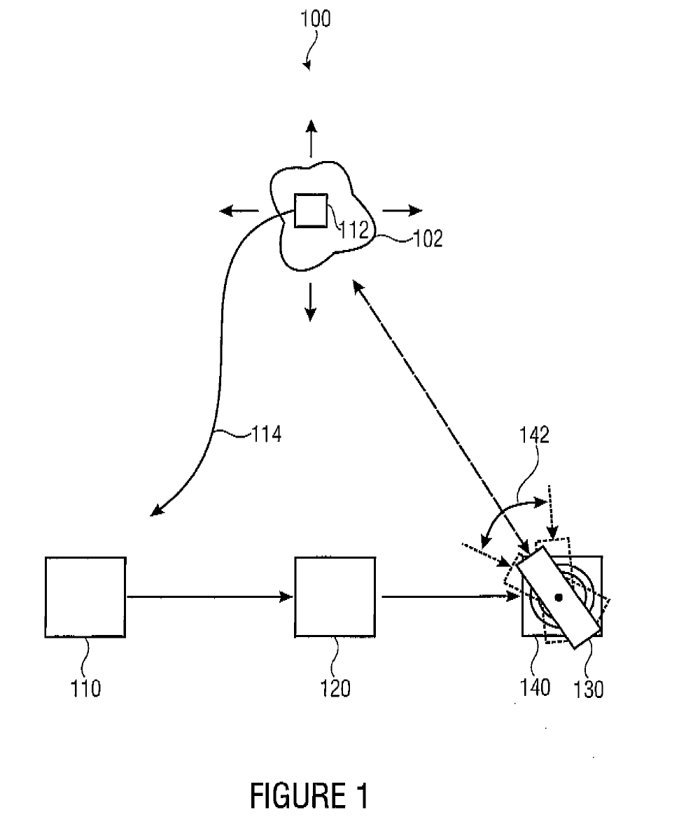

FIG. 1 shows a schematical illustration of a device 100 for tracking a moving object 102 according to an embodiment according to the invention. The device 100 includes a receiver 110, an evaluation unit 120, a camera 130 and a control unit 140 for aligning 142 the camera 130 to the moving object 102. The receiver 110 is here implemented to receive a signal 114 transmitted from a mobile transmitter 112 located at the moving object 102 and following movements of the object 102. From the received signal 114 the evaluation unit determines position data of the moving object 102. Then, the control unit 140 aligns the camera 130 to the moving object 102 based on the determined position data.

The alignment or orientation 142 of the camera 130 may, as illustrated in FIG. 1, be executed by a rotational movement in one plane. By this, a tracking in two dimensions is enabled. The control unit 140 may, however, be extended such that the camera 130 may additionally be moved in a second plane which is orthogonal to the first plane of movement. By this, the camera 130 may be aligned with the moving object 102 in three dimensions.

Further, the receiver 110, the evaluation unit 120 and the control unit 140 with the camera 130 may be arranged separately, as illustrated in FIG. 1, wherein the receiver 110 and the evaluation unit 120 as well as the evaluation unit 120 and the control unit 140 are, for example, connected by communication channels. Likewise, it is also possible to integrate the receiver 110 and the evaluation unit 120 directly in the control unit 140 and the camera 130.

As long as the signals of the mobile transmitter may reach the receiver, a tracking of the moving object may be executed even if the object to be tracked is hidden by another object. By the use of an infrared camera, for example, the moving object may not only be tracked despite it being hidden but also be made visible.

In some embodiments according to the invention, the position data of the moving object result from the relative position of the moving object to the position of the receiver. Another possibility for embodiments would be, for example, that the mobile transmitter comprises a unit for receiving GPS signals (GPS=global positioning system) or Galileo signals (European project for global position determination) and directly transmits the position data determined thereby to the receiver.

In further embodiments according to the invention, the device is implemented to activate the tracking of the object only after detecting an alarm. For example, a burglary or an assault may trigger an alarm which may be detected by the device.

Some embodiments according to the invention include an array antenna comprising at least three antennae which are spaced apart from each other. By a clever arrangement of the individual antennae, position data, like, for example, angles or distances, may be determined from the signal from the mobile transmitter by prior methods, for example by phase evaluation of the antenna arrangement (e.g. ESPRIT method: method for signal parameter estimation by technologies based on shifting invariances) or by an evaluation of run-time differences of signals (e.g. round-trip method).

In further embodiments according to the invention the camera is implemented to be rotatable in a plane around any angle. By this, for example, a camera which is, for example, mounted on a tripod or on the ceiling of room may be aligned in any direction in a plane which may be parallel to the floor or the ceiling. By extending the control unit by a further direction of movement for the camera, which takes place in a plane which is orthogonal to the first plane, in the above-mentioned example the camera may be aligned in three dimensions by mounting the camera on a tripod or on the ceiling. By this it is possible to track the moving object in a wide range using only one camera.

In some embodiments according to the invention, the mobile transmitter is implemented to be able to receive a signal from the receiver. By this it is possible that information is transmitted to the transmitter, such as, for example, whether tracking or monitoring is currently taking place or which camera is currently tracking the transmitter.

In principle it is possible to use any transmitter which transmits signals with a frequency of >800 MHz and with which the device may directly communicate (peer2peer: “peer to peer”). Some embodiments according to the invention, however, relate to transmitters and receivers which are implemented to operate in a frequency band between 2.4 GHz and 2.5 GHz.

In some embodiments according to the invention, for a wireless communication a so-called “WiSmIt” transmitter (“WiSmIt”=wireless smart item) is used. The same detects its acceleration, rotation, air pressure and temperature via an integrated sensor technology and contains an RFID reader (“radio frequency identification”, identification with the help of electromagnetic waves), for example for logistic purposes. This data may be wirelessly transmitted via a bidirectional (data may be exchanged in both directions) communication channel to the receive system in the 2.4 GHz band.

Additionally, the receive system may detect the distance to the transmit module as additional position information, for example for the setting of the zoom (the enlargement) and the focus of the camera, via a ranging method (determining the distance between receive/transmit units). The “WiSmIt” transmitter provides an integrated ranging function for this purpose.

The localization of the moving object may, for example, be executed by a two-dimensional measurement of angle and distance or by a three-dimensional measurement of distance and triangulation. Alternatively, for example a WLAN-capable device (WLAN: “wireless local area network”) may be used. Here, the localization of the moving object may, for example, be executed by a one-dimensional measurement of an angle or by a two-dimensional triangulation.

In some embodiments according to the invention the device serves for a dynamic camera surveillance and is implemented as a cooperative system. The cooperativity may be guaranteed by the monitored or tracked object, respectively, carrying an active transmitter possibly comprising a feedback channel for information as to which camera is tracking the same. A sensor is located on the camera including the receiver and the transmitter which determines the coordinates of the transmitter, for example from the incoming radio wave.

Some embodiments according to the invention are a sensor system comprising position determination, which may be used in different applications due to its variability. For example, its use as a sensor for camera systems is possible.

Further embodiments according to the invention relate to a system which may determine the position from which radio signals, for example in a 2.4 GHz frequency band, impinge on the receive antenna in real time. By this it is for example possible to perform a localization and identification of the signals using this system and thus to intelligently direct and/or align the camera head to the object. A controllable camera head thus becomes an intelligent autonomous system for automatically tracking mobile transmit units with manifold areas of use, for example in surveillance services, at events or in traffic telematics.

Some embodiments according to the invention relate to an STC system (STC=sentry tracking camera) which includes, among other things, an antenna unit, a current supply, communication software and a mobile transmitter module.

Further embodiments according to the invention describe a device comprising an antenna unit. This antenna unit may include an array antenna for receiving a radio signal at 2.4 GHz, a sensitive HF receiver (HF=high frequency), an integrated digital signal processing for signal conditioning, identification and data extraction, and a processing unit for calculating position data. The identification may here, for example, relate to the differentiation of signals of different mobile transmitters. This antenna unit thus includes the receiver and the evaluation unit.

The antenna unit may here, for example, be supplied directly with 12 to 28 volts direct current or an external 250 volts power supply may be selected. A typical value for the power input would, for example, be 35 watts.

In some embodiments according to the invention, the device is implemented so that settings and actions may be remote-controlled and configured using an internet browser (internet browser: software for representing internet pages). For monitoring, for example an additional PC program with alarm-activation possibilities according to the standard X733 is used.

Further embodiments according to the invention relate to a system in which “WiSmIt” 2.45 GHz modules having an integrated motion sensor system and a data interface are used as transmitters or transmitter modules, respectively. Optionally, also WLAN-capable devices (WLAN: wireless local area network) or special communication systems may be included.

In further embodiments according to the invention, the evaluation unit or a digital signal processing unit, respectively, is equipped with a high-speed interface (approx. 2 gigabits per second). The same may, for example, be used for a combined video transmission and data communication between several antenna units or receivers, respectively, and a master. Interfacing may, for example, be via an optical waveguide.

Some embodiments according to the invention relate to an STC system (STC: “sentry tracking camera”), which may be used as a complete positioning system by means of several antenna units and a central server. By this, for example further tasks in the fields of logistics, production and security may be realized.

Further embodiments according to the invention relate to an STC system which may be adapted to frequencies between 868 MHz to 6 GHz. While the receiver and the signal processing unit or evaluation unit, respectively, may already be prepared for this, for physical reasons the construction of the antenna unit changes depending on the desired frequency.

Some embodiments according to the invention relate to a universally usable positioning unit and, for example, offer a cost-efficient, fast and simple way of integrating different products, like, for example, different camera systems. The system itself, and also the additional modules, like, for example, the high-speed interface, are designed for use in prototypes and in the setup in laboratories and also for direct use in a product.

In some embodiments according to the invention, the device for servicing and monitoring comprises an interface, like, for example, an RS232 Ethernet interface (RS232: standard for a serial interface, “Ethernet”: cable-bonded data network technology) or a USB1.1. interface (USB: “universal serial bus”). Further, an interface for outputting angular measurements may be provided and, by means of the “WiSmIt” transmitter, for distance outputs via Ethernet, TCP/IP (TCP/IP: “transmission control protocol/internet protocol”) or UDP (UDP: “user datagram protocol”, minimum, connectionless network protocol).

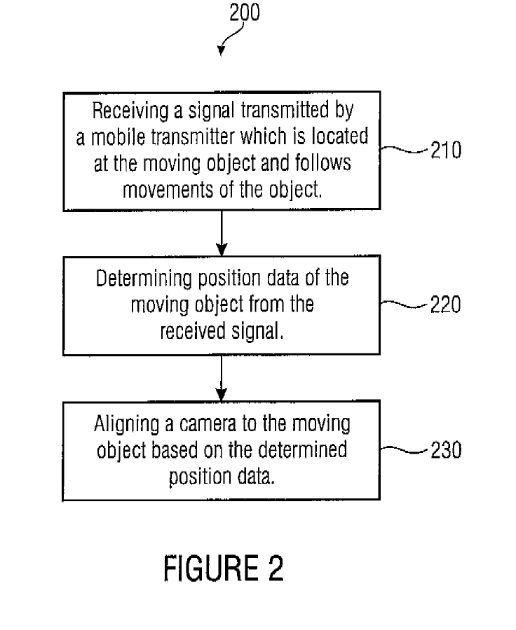

FIG. 2 shows a method 200 for tracking a moving object according to an embodiment according to the invention. The method comprises receiving 210 a signal, determining 220 position data of the moving object and aligning 230 a camera.

The received signal is transmitted by a mobile transmitter which is located at the moving object and follows movements of the object.

The position data of the moving object is determined from the received signal.

The camera is aligned to the moving object based on the determined position data.

While this invention has been described in terms of several embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations and equivalents as fall within the true spirit and scope of the present invention.

Although some claims only relate to one other claim, also a combination with further claims may be possible.

In particular, it is pointed out that, depending on the conditions, the inventive scheme may also be implemented in software. The implementation may be on a digital storage medium, particularly a floppy disk or a CD with electronically readable control signals capable of cooperating with a programmable computer system so that the corresponding method is executed. In general, the invention thus also consists in a computer program product with a program code stored on a machine-readable carrier for performing the inventive method, when the computer program product is executed on a computer. Stated in other words, the invention may thus also be realized as a computer program with a program code for performing the method, when the computer program product is executed on a computer.

1. A device for tracking a moving object, comprising:
a receiver which is implemented to receive a signal transmitted by a mobile transmitter which is located at the moving object and follows movements of the object;
an evaluation unit for determining position data of the moving object from the received signal;
a camera; and
a control unit for aligning the camera to the moving object based on the determined position data.

2. The device according to claim 1, wherein the signal between the transmitter and the receiver is a radio signal.

3. The device according to claim 1, wherein the position data of the moving object result from a relative position of the moving object with regard to the position of the receiver.

4. The device according to claim 1, which is implemented to activate the tracking of the object upon the detection of an alarm.

5. The device according to claim 1, comprising a further camera and being implemented to hand over the tracking of the object from the first camera to the further camera.

6. The device according to claim 1, wherein the receiver comprises an array antenna with a plurality of spaced apart antennae.

7. The device according to claim 6, wherein the evaluation unit is implemented to calculate the position data of the moving object by a phase evaluation of the signal received at the antennae of the array antenna.

8. The device according to claim 1, which is implemented to calculate the distance of the moving object by an evaluation of run-time differences of signals.

9. The device according to claim 1, wherein the camera is rotatable in a plane around any angle.

10. The device according to claim 6, wherein the array antenna of the receiver comprises at least three antennae.

11. The device according to claim 1, wherein the evaluation unit is implemented to recover an identification feature of the mobile transmitter from the received signal.

12. The device according to claim 1, wherein the evaluation unit is implemented to recover identification features of different mobile transmitters from received signals, wherein a switch for switching the alignment of the camera is provided between the different mobile transmitters.

13. A system for tracking a moving object comprising a device for tracking a moving object, comprising:
a receiver which is implemented to receive a signal transmitted by a mobile transmitter which is located at the moving object and follows movements of the object;
an evaluation unit for determining position data of the moving object from the received signal;
a camera; and
a control unit for aligning the camera to the moving object based on the determined position data,
and comprising the mobile transmitter.

14. The system according to claim 13, wherein the mobile transmitter is implemented to activate or deactivate the transmission of the signal.

15. The system according to claim 13, comprising a further mobile transmitter, wherein the first transmitter and the further transmitter comprise different identification features and are implemented to transmit the identification feature with the signal.

16. The system according to claim 13, wherein the mobile transmitter is implemented to be able to receive a signal from the receiver.

17. The system according to claim 13, wherein the transmitter and the receiver are implemented to operate in a frequency band between 2.4 GHz and 2.5 GHz.

18. The system according to claim 13, wherein the mobile transmitter is implemented as a “WiSmIt” module or as a WLAN-capable device.

19. A method for tracking a moving object, comprising:
receiving a signal transmitted by a mobile transmitter which is located at the moving object and follows movements of the object;
determining position data of the moving object from the received signal; and
aligning a camera to the moving object based on the determined position data.

20. A computer readable medium storing a computer program with program code for performing the method according to claim 19, when the computer program runs on a computer or a microcontroller.
